(19) United States
(12) Patent Application Publication
(10) Pub. No.: US 2008/0147692 A1
(43) Pub. Date: Jun. 19, 2008

(54) METHOD FOR MANIPULATING THE CONTENTS OF AN XML-BASED MESSAGE

(75) Inventors: Matthew N. Hovey, Royal Oak, MI (US); Mark A. D'Errico, Farmington Hills, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GENERAL MOTORS CORPORATION, Detroit, MI (US)

(21) Appl. No.: 11/610,560

(22) Filed: Dec. 14, 2006

(51) Int. Cl. G06F 17/30

(52) U.S. Cl. 707/101; 707/E17.005

(57) ABSTRACT

A method for manipulating some of the contents of an XML file in order to standardize and optimize its user-defined portions without breaking the XML syntax. More specifically, the manipulation method can standardize various user-defined terms developed by different authors, thus producing XML-based messages utilizing a more consistent and familiar set of terms. At the same time, the manipulation method optimizes the user-defined terms in a manner that reduces the amount of data associated with the resultant XML-based message. This standardized and optimized set of user-defined terms results in the use of fewer bytes of information per XML-based message, which can translate into faster and less expensive data transmissions. The manipulation method is particularly well suited for use with SOAP-compatible XML files that are used in conjunction with wireless vehicle communications systems.

### TECHNICAL FIELD

The present invention relates generally to data communications, and more specifically, to a method for manipulating the contents of data communications, such as XML-based messages, in order to standardize and optimize those contents.

### BACKGROUND OF THE INVENTION

A wide variety of wireless communications devices are used to transmit and receive data, including cell phones, PDAs, modems, and vehicle communications devices, to name but a few. Many of these devices use one or more types of communication channels, including voice and data channels, to provide a variety of services over wireless networks. Some devices utilize data encoding techniques to communicate data information over a voice channel, while other devices use a data channel to send data information.

As the range of offered services increases, so too does the amount of transmitted data needed to provide those services. An increased amount of transmitted data can, for example, slow down communication networks, increase airtime charges that are tied to data traffic, and put strain on various communication resources. Thus, it can be advantageous to employ techniques that reduce the amount of data associated with each data message being sent.

### SUMMARY OF THE INVENTION

According to one aspect of the invention, there is provided a method for manipulating some of the contents of an XML file that can be used to develop an XML-based message for transmission over an Internet protocol (IP) network. The method generally comprises the steps of: (a) receiving an XML file; (b) reviewing the XML file in order to identify manipulatable content that can be altered without breaking the syntax of XML; (c) reviewing the manipulatable content of the XML file in order to identify an initial string that can be exchanged with a replacement string; and (d) searching the manipulatable content of the XML file for the initial string and exchanging each occurrence of the initial string with the replacement string.

According to another aspect of the invention, there is provided a method for manipulating some of the contents of a schema file, wherein the schema file can be used to develop a SOAP-compatible XML-based message for transmission over an Internet protocol (IP) network established between a vehicle telematics unit and a telematics service provider. The method generally comprises the steps of: (a) receiving the schema file; (b) reviewing the schema file in order to identify user-defined terms that can be altered without breaking the syntax of XML; (c) creating a name list that includes a plurality of names from the user-defined terms; (d) creating a word list that includes a plurality of words from the user-defined terms; and (e) searching the schema file for the pluralities of names and words and replacing the names and words that are found with shorter names and words, respectively.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a diagrammatic representation of an exemplary Internet protocol (IP) network, shown in the form of an Internet protocol suite or stack; and

FIG. 2 is a flow chart demonstrating some of the steps of an embodiment of a method for manipulating the contents of an XML-based message that can be sent over an IP network.

### DETAILED DESCRIPTION OF THE PREFERRED EMBODIMENTS

The method described below can be used to manipulate some of the contents of an XML-based message in order to standardize and optimize its user-defined portions without breaking the XML syntax. More specifically, the manipulation method can standardize various user-defined terms developed by different authors, thus producing XML-based messages utilizing a more consistent and familiar set of terms. At the same time, the manipulation method optimizes the user-defined terms in a manner that reduces the amount of data associated with the resultant XML-based message. This standardized and optimized set of user-defined terms can be beneficial for a number of reasons, not least of which is that it generally results in the use of fewer bytes of information per XML-based message which can translate into faster and less expensive data transmissions. The manipulation method disclosed herein can be used with any XML file, but it is particularly well suited for use with XML files that are SOAP compatible and are used in conjunction with a wireless vehicle communications system.

Broadly speaking, Extensible Markup Language (XML) is a general-purpose markup language that is approved by the World Wide Web Consortium (W3C) and supports a wide variety of applications. A markup language generally combines text with additional information about the text, such as markup instructions, in the same data stream or file. Character data, such as the Universal Character Set, may represent textual data. XML is a subset of the Standardized General Markup Language (SMGL) and one of its primary purposes is to facillitate the sharing of information across different information systems, most notably various systems connected by and to the Internet.

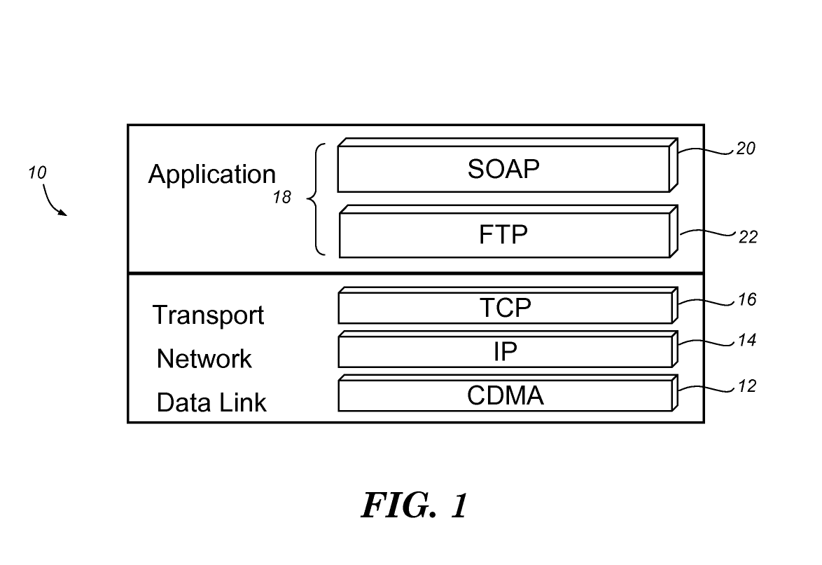

XML files can be used to create XML-based messages that are sent across a multi-layer Internet protocol (IP) network, such as the Internet. With reference to FIG. 1, a diagrammatic representation of an exemplary IP network is shown in the form of an Internet protocol suite 10 (also referred to as a TCP/IP protocol suite or stack), which includes four separate primary layers that generally comprise the basic set of communication protocols on which the Internet and most commercial networks run. Each of the layers is designed to perform a certain set of tasks or solve a particular set of problems relating to data transmission, and only interacts with the layers immediately below and immediately above it. Accordingly, each layer in Internet protocol suite 10 performs services for the adjacent layer above it and makes requests of the adjacent layer below it. The upper layers in the Internet protocol suite are generally closer to the end user and deal with more abstract data, while those layers lower in the suite are generally closer to the hardware and pertain more to issues dealing with actual data transmission. It should be appreciated that the illustrative Internet protocol suite 10 is simply an abstract model of a layered IP network and that numerous other abstract models could be used instead. Various protocol layer names and layer combinations are oftentimes used to describe layered networks of this nature. For instance, instead of using the four-layer Internet protocol suite shown in FIG. 1 to represent an IP network, a five-layer Internet protocol suite or the commonly used seven-layer OSI model could be used instead.

Internet protocol suite 10 preferably includes a data link layer 12, a network layer 14, a transport layer 16, and an application layer 18, but can have one of any number of different protocol layer names and/or combinations known in the art. According to a preferred embodiment, Internet protocol suite 10 uses Code Division Multiple Access (CDMA) or another radio frequency (RF) protocol at the data link layer 12, an IP protocol at the network layer 14, and Transmission Control Protocol (TCP) at the transport layer 16. Because various embodiments of layers 12-16 are widely known in the art, the following description focuses more on the Application Layer 18, which can include several sub-layers.

Application layer 18 generally coordinates the communications and manages the dialog between two peers, and is somewhat analogous to the combination of the application, presentation, and session layers of the seven-layer OSI model. If data is to be transmitted through a network configured with Internet protocol suite 10, then application layer 18 encapsulates the data in a transport layer protocol before passing it along to the transport layer 16. If, on the other hand, data is to be transmitted to another application layer on a peer-to-peer basis, then the data is encapsulated in an application layer protocol before it is transmitted. The application layer may also be delineated into one of a number of different combinations of sub-layers, including the exemplary two sub-layer combination 20-22 shown in FIG. 1 which includes an envelope sub-layer 20 that is closest to the end user and can help define the envelope format.

One example of a suitable envelope sub-layer protocol is Simple Object Access Protocol (SOAP), which has the advantage of being readable by humans but is also rather verbose. As will be appreciated by those skilled in the art, SOAP is a protocol that is generally used to exchange XML-based messages over an IP network, and forms a basic messaging foundation that can be used within a Web Service Protocol stack (not shown). The SOAP protocol defines an XML envelope format that may contain an XML payload. There are several different types of messaging patterns in SOAP, however, the most common of those is the Remote Procedure Call (RPC) pattern. An RPC pattern uses a first network node (referred to as a SOAP sender) to send a request message to a second network node (referred to as a SOAP receiver), in reply to which the SOAP receiver immediately sends a response message back to the SOAP sender. A SOAP application layer is an entity, typically software, that produces, consumes or otherwise acts upon XML-based messages in a manner conforming to the SOAP processing model. Additionally, a SOAP handler, which may be a SOAP receiver or SOAP sender, preferably resides in an appropriate location, such as a telematics unit located in a vehicle, so that the telematics unit can exchange SOAP-compatible XML-based messages with one or more other devices. According to one embodiment, XML-based messages are wirelessly sent and received between a vehicle telematics unit and a remotely-located telematics service provider, such as a call or data center.

Application layer sub-layer 22 resides underneath envelope sub-layer 20 and can utilize one of a number of different protocols, including file transfer protocol (FTP). As can be appreciated by those skilled in the art, FTP is a suitable sub-layer protocol that is commonly used for exchanging files over layered IP networks. Of course, FTP is only one example of a suitable envelope sub-layer protocol. Other suitable examples include, but are certainly not limited to, Hypertext Transfer Protocol (HTTP), Simple Mail Transfer Protocol (SMTP), Blocks Extensible Exchange Protocol (BEEP), Session Initiation Protocol (SIP) or Java Message Service (JMS). Again, the foregoing Internet protocol suite 10 is simply an abstract model of one possible exemplary IP network, as XML-based messages could be sent across numerous other networks as well.

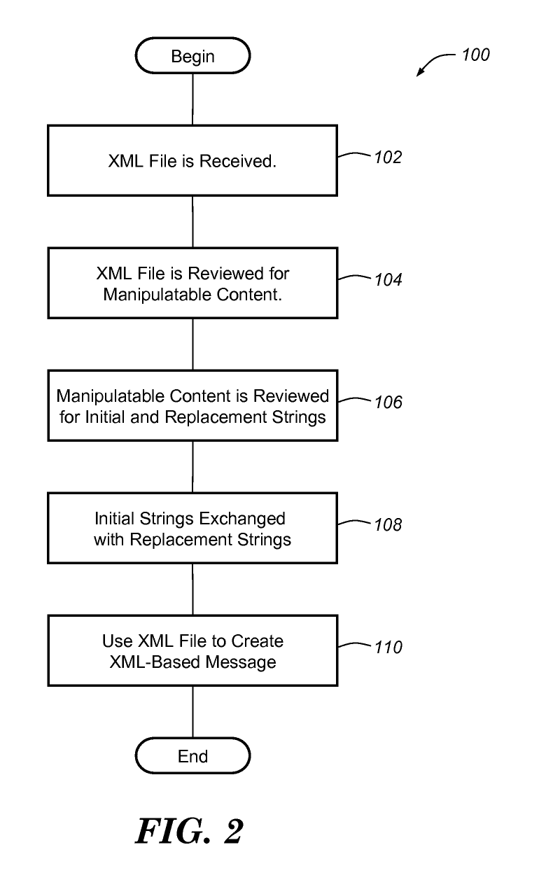

Turning now to FIG. 2, there is shown a flow chart having some of the steps of an exemplary embodiment of a manipulation method 100 that modifies the contents of an XML-based message so that the message remains syntactically intact with the XML language, but is standardized and optimized to some degree. Preferably, manipulation method 100 streamlines SOAP-compatible XML-based messages so that they have fewer bits of information and can therefore be transmitted over an IP network with greater speed and less expense and require fewer networking resources.

One way in which the manipulation method accomplishes this is by reducing the size of user-defined terms or other manipulatable contents of an XML file without contravening the syntax of the XML language, and then using the smaller terms throughout the XML file; a process that is broadly referred to as optimization. In addition to optimizing, the manipulation method also standardizes these terms so that a more uniform set of nomenclature is created and is available for use by different authors of XML files.

Beginning with step 102, an XML file is received from one of a number of possible sources. An ‘XML file’ broadly includes any electronic file that can be used during the creation of an XML-based message including, for example, schema files, Web Services Description Language (WSDL) files, or any other file type known to those skilled in the art. According to one embodiment, the XML file received in step 102 is a schema file (some examples are XSD, DDML, DSDL, DSD, DTD, NRL, SGML, SOX, XDR, WXS, RELAX NG, and Schematron files) which provides a view of the document type at a relatively high level of abstraction, and includes manipulatable content. Usually, a schema file is expressed in terms of structure and content constraints which go beyond the general syntactical constraints imposed by the XML language itself.

The actual reception of the XML file may be accomplished in any suitable manner that transmits a file from one device to another. For instance, the file could be electronically sent in an email, it could be downloaded through the use of a website or similar web-based resource, it could be retrieved from a networked database or other data storage device, or it could simply be saved to a portable storage device and then delivered by hand, to name but a few of the possibilities. According to one embodiment, an XML schema file is created by an author such as an engineer or computer programmer, and is then saved to a networked database that makes it available to properly authorized users throughout the network.

Next, the XML file is reviewed in order to identify any manipulatable content that can be altered without breaking the syntax of XML, step 104. ‘Manipulatable content’ broadly refers to all content within an XML file that can be manipulated or otherwise altered, established, changed, etc. without breaking the syntax of the XML language. Put differently, manipulatable content includes some of the discretionary portions of the XML file that do not form the syntactical rules of the language itself, such as user-defined terms, and can generally be located throughout the XML file. XML syntax may be interweaved with user-defined characters yet still conform to XML language constraints. Once the manipulatable content of the XML file has been identified, it can be copied, extracted, set aside, processed, manipulated, or simply left alone before proceeding to step 106.

Step 106 involves reviewing the manipulatable content that was identified in the previous step, and identifying one or more initial string(s) that can be exchanged with one or more replacement string(s). As previously explained, certain portions of the XML file are manipulatable or editable. Thus, this step evaluates the editable portions of the XML file and looks for one or more strings of characters that can be replaced with shorter character strings in order to optimize the resulting XML-based message. The string of characters being replaced is referred to as an ‘initial string’, and the string of alternative characters that it is being replaced with (usually, the shorter string) is referred to as the ‘replacement string’. It should be noted that in certain instances, the initial string could be shorter in length than the replacement string. The actual method or technique used to review the manipulatable content of the XML file can vary from embodiment to embodiment, and can include the use of a computer program or manual review. In either case, this review preferably generates a list of initial strings and replacement strings that can be used in subsequent steps.

According to one possible search-and-replace technique, the manipulatable content that was identified in step 104 is searched by a computer program so that a list of possible replacements can be developed. In order to help illustrate this technique, a brief description of an exemplary XML file, in this case a SOAP-compatible schema file, may be helpful. The XML file is directed towards a particular ‘service’ which is similar to a topic, subject or theme for the XML file. As examples, a schema file could be developed that is directed to a vehicle safety-related service such as crash detection, a navigation-related service, or a diagnostic trouble code (DTC)-related service. Preferably, there is one schema file per service, however, there could be one schema file for multiple services or vice-versa. The service further includes one or more ‘incidents’ which are events, occurrences, conditions, etc. that pertain to the associated service. In the foregoing example of the vehicle safety-related service, the incidents could include a front driver side impact, a front passenger side impact, a rear driver side impact, a rear passenger side impact, etc. Each of these incidents is an event that pertains to the more general category of vehicle safety. In each incident, there is typically found one or more user-defined ‘elements’, which can include two tags (start and end tags each having angled brackets around a title) that surround components such as names, attributes, sub-elements or other content, as appreciated by those skilled in the art. Names, which are but one possible component of an element, can be further divided into ‘words’ which are simply smaller sub-components of names. Finally, names, words, attributes, titles, as well as other components of the XML file are generally comprised of ‘characters’, which can be selected from the Universal Character Set (UCS) and generally form the building block of the XML file.

Returning to the search-and-replace technique mentioned above, a computer program could be created that automatically evaluates the manipulatable content of an XML file so that potential initial and replacement strings can be identified. The computer program divides pieces of manipulatable content, such as names, into their constituent components for further analysis and possible replacement. As an example, an XML file could contain the element: <xs:element name=“Airbag Deployment Detected Example” type=“xs:boolean”/>. The string “Airbag Deployment Detected Example” is a user-defined name (manipulatable content) and can be further broken up into words, as described above. The words “Airbag,” “Deployment,” Detected,” and “Example” are each comprised of a number of characters. When words are of relatively short length, it may not be necessary to replace them with a shorter or smaller alternative word. Other words, like “Deployment” which includes ten characters, may be long enough that replacement is warranted. For instance, the word “Deployment” could be replaced by “Dpl” and the word “Example” could be replaced with “Ex,” each of which significantly shortens the amount of information associated with that word. Similarly, the entire name “Airbag Deployment Detected Example” could be replaced with a shorter name, such as “ArbgDplDetEx.” When a name, word, or any other string of characters is identified for replacement, that string is referred to as the initial string (“Deployment” and “Example” in the example above), and the alternative is referred to as the replacement string (“Dpl” and “Ex” above).

There are a number of techniques and algorithms that the computer program can use to select appropriate initial and replacement strings. According to one of those, the program searches the manipulatable data for all names words by looking for the beginning of each as distinguished by a capitalized character, a preceding space, or some other indicator. Each name is then put into a ‘name list’ that is copied into a spreadsheet, document, array, database, or some other file. In addition to including all of the manipulatable names located by the program, the name list can also have statistical information such as the number of times each name shows up within the XML file, and the number of characters per name, for example. This type of information can be helpful when one is trying to determine which names are the most beneficial to replace. A similar list, referred to as a ‘word list’, could be developed for words showing up in the XML file. The list of words could be derived from the XML file itself or it could be taken from the name list; that is, the word list is generated by breaking down each of the names on the name list into its constituent parts.

For instance, if the program found the name “Airbag Deployment Detected Example,” it could add that name to the name list, as well as add the number of times it shows up in the XML file and the number of characters per occurrence (thirty-four characters, including spaces). If that name was present ten times in the XML file, then there are a total of three hundred forty characters used in the XML file for that name. Furthermore, the program could extract the individual words on the basis of either capitalization or preceding spaces, and could then save the words “Airbag,” “Deployment,” “Detected,” and “Example” as entries in the word list, as well as their statistical information regarding the number of characters for each word (six characters for “Airbag” for example) and the number of times that word appeared in the XML file. Once all of the names and/or words that are potentially available for shortening have been identified, the method either prompts a user to provide shortened alternatives (replacement strings), looks to previously established lists of strings to see if a replacement string has already been established, or applies some automatic string shortening algorithm, to name but a couple of possible approaches. Step 106 is generally complete when a list of initial strings and corresponding replacement strings have been developed.

Next, step 108 searches the manipulatable content of the XML file for each initial string and exchanges that string with a replacement string. Preferably, the computer program only searches the manipulatable portions of the XML file like the element and attribute names (results in a quicker search and reduces the possibility of interfering with the XML syntax) and compares them to the list of initial strings that was previously created. It is, of course, possible to search the entire XML document instead of just the manipulatable portions; if this approach is taken, then some type of additional determination should be made to make sure that the substitution does not violate the XML syntax. When a match is found, the program replaces the initial string with its corresponding replacement string. According to one embodiment, a recursive algorithm may be used to locate or match names, words, or other character data in the XML file to initial strings. Unlike a simple find and replace algorithm, the recursive algorithm searches for strings of characters, be it names or words, in decreasing order of size. For example, if a name is comprised of four sequential words (c1, c2, c3 and c4), then the recursive algorithm looks for initial strings in the following order:

c1c2c3c4; c1c2c3; c2c3c4; c1c2; c2c3; c3c4; c1; c2; c3; c4.

If a string, such as a word, matching an initial string is located, the program replaces the matched string in the XML file with the corresponding replacement string without breaking the XML syntax. Only manipulatable contents like names, words or other characters are replaced. For example, if the recursive algorithm finds the name “Airbag Deployment Detected Example” in a manipulatable portion of the XML file, then the algorithm would replace the entire string with a corresponding replacement string, such as “ArbgDplDetEx,” before attempting to locate and replace each of the individual words “Airbag,” “Deployment,” “Detected,” and “Example.” After the various names have been searched for and replaced, if any words like “Deployment” are found, then their corresponding replacement string is inserted into the XML file in lieu of the initial string. If there is no corresponding replacement string, then the XML file is not changed. As discussed before, it is preferable to substitute those initial strings that contain the most characters and/or that are present the most times in the XML file, as such substitutions result in the greatest data reductions.

Once the schema or other XML file has been optimized and standardized, a corresponding XML-based message can be created, step 110, as is appreciated by those skilled in the art. Again, it is preferable that the XML-based message be deliverable over a wireless IP network established between a vehicle telematics unit and another party, such as a telematics service provider.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For instance, all though the preceding examples were provided in the context of searching are replacing names or words found in XML elements, other manipulatable parts of an XML file could also be replaced. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. As used herein, the various forms of the word “optimize” are not meant to be limited to finding the best possible result, but only to improving the result so that, for example, optimizing the manipulatable content can be achieved by reducing the size of the manipulatable content even though that content could possibly be further reduced.

Other terms are to be construed using their broadest reasonable meaning unless they are used in a context that requires a different interpretation.

1. A method for manipulating some of the contents of an XML file that can be used to develop an XML-based message for transmission over an Internet protocol (IP) network, comprising the steps of:
(a) receiving an XML file;
(b) reviewing the XML file in order to identify manipulatable content that can be altered without breaking the syntax of XML;
(c) reviewing the manipulatable content of the XML file in order to identify an initial string that can be exchanged with a replacement string; and
(d) searching the manipulatable content of the XML file for the initial string and exchanging each occurrence of the initial string with the replacement string.

2. The method of claim 1, wherein the method optimizes some of the manipulatable content of the XML file by reducing the size of user-defined terms without contravening the syntax of the XML language.

3. The method of claim 1, wherein the method standardizes some of the manipulatable content of the XML file by using common user-defined terms without contravening the syntax of the XML language.

4. The method of claim 1, wherein the XML-based message is a SOAP-compatible XML-based message.

5. The method of claim 1, wherein the XML-based message is wirelessly sent over an IP network established between a telematics unit located on a vehicle and a telematics service provider.

6. The method of claim 1, wherein step (a) further comprises receiving an XML schema file, the schema file generally pertains to at least one service and includes one or more incidents, each of the incidents includes one or more elements, and each of the elements includes one or more characters.

7. The method of claim 6, wherein the service is a vehicle-related service and is selected from the group consisting of: a safety-related service, a navigation-related service, and a diagnostic trouble code (DTC)-related service.

8. The method of claim 1, wherein step (c) further comprises creating a name list from the manipulatable content of the XML file, wherein the name list includes a plurality of names and is used to identify the initial string.

9. The method of claim 8, wherein the name list includes at least one piece of statistical information selected from list consisting of: the number of times a name appears in the XML file and the number of characters per name.

10. The method of claim 8, wherein each of the plurality of names is determined by looking for a capitalized character, a preceding space, or some other indicator.

11. The method of claim 1, wherein step (c) further comprises creating a word list from the manipulatable content of the XML file, wherein the word list includes a plurality of words and is used to identify the initial string.

12. The method of claim 1 1, wherein the word list includes at least one piece of statistical information selected from list consisting of: the number of times a word appears in the XML file and the number of characters per word.

13. The method of claim 11, wherein each of the plurality of words is derived from a name list and is determined by looking for a capitalized character, a preceding space, or some other indicator.

14. The method of claim 1, wherein step (d) further comprises searching the manipulatable content of the XML file by employing a recursive algorithm that searches for strings of characters in decreasing order of size.

15. The method of claim 1, wherein step (c) further comprises identifying the initial string at least partially based on the number of characters in the initial string or the number of times the initial string is present in the XML file.

16. A method for manipulating some of the contents of a schema file, the schema file can be used to develop a SOAP-compatible XML-based message for transmission over an Internet protocol (IP) network established between a vehicle telematics unit and a telematics service provider, comprising the steps of:
(a) receiving the schema file;
(b) reviewing the schema file in order to identify user-defined terms that can be altered without breaking the syntax of XML;
(c) creating a name list that includes a plurality of names from the user-defined terms;
(d) creating a word list that includes a plurality of words from the user-defined terms; and
(e) searching the schema file for the pluralities of names and words and replacing the names and words that are found with shorter names and words, respectively, so that some of the contents of the XML file are optimized and standardized without breaking the syntax of XML.

17. The method of claim 16, wherein the schema file generally pertains to at least one service and includes one or more incidents, each of the incidents includes one or more elements, and each of the elements includes one or more characters.

18. The method of claim 17, wherein the service is a vehicle-related service and is selected from the group consisting of: a safety-related service, a navigation-related service, and a diagnostic trouble code (DTC)-related service.

19. The method of claim 16, wherein the name list includes at least one piece of statistical information selected from list consisting of: the number of times a name appears in the XML file and the number of characters per name.

20. The method of claim 16, wherein the word list includes at least one piece of statistical information selected from list consisting of: the number of times a word appears in the XML file and the number of characters per word.

21. The method of claim 16, wherein step (e) further comprises searching the schema file by employing a recursive algorithm that searches for strings of characters in decreasing order of size.

22. The method of claim 16, wherein step (e) further comprises replacing the names and words that are found at least partially based on the number of characters in the initial string or the number of times the initial string is present in the schema file.
